(19) United States
(12) Patent Application Publication
(10) Pub. No.: US 2009/0293695 A1
(43) Pub. Date: Dec. 3, 2009

(54) Cutting apparatus for rolled sheet goods

(76) Inventor: Thomas F. Sacchetta, Media, PA (US)

Correspondence Address: Douglas Wm. Massinger, Esq.;Massinger Law Offices, 887 N.E. 100 Street, Ocala, FL, 34479, US

(21) Appl. No.: 12/156,615

(22) Filed: Jun. 2, 2008

(51) Int. Cl. B26D 5/08; B26D 7/00

(52) U.S. Cl. 83/614; 83/649

(57) ABSTRACT

A cutting apparatus for top and front dispensing containers for rolled sheet goods is comprised generally of: 1) a pivotable track assembly capable of engaging and immobilizing a sheet for cutting as more fully described herein, 2) a pair of opposing hinge arms each fixedly attached at their distal end to the opposing ends of the track assembly, 3) mounting means attached to the proximal ends of the hinge arms for mounting of the track assembly to opposing side walls of the container in pivotable fashion, and 4) a cutting assembly slidably disposed on the track assembly. When mounted to the container, the track and cutting assemblies may be rotated from an open sheet loading position to a closed sheet trapping and cutting position against the cutting surface which in one embodiment may be backing strip mounted to the container.

### FIELD OF THE INVENTION

The subject invention relates generally to slidable cutters for severing sheet materials, and more particularly to a detachable and pivotable cutting assembly used to cut rolled sheet goods dispensed from conventional storage containers.

### BACKGROUND OF THE INVENTION

Sheet goods such as aluminum foil, plastic wrap and wax paper are commonly sold in rolled form within cardboard cartons equipped with a longitudinally disposed strip of sharp serrated metal which serves as a means for severing any length of sheet from the parent body. Such strips are often attached along the bottom edge of the carton such that their sharp teeth project in a downward direction. Accordingly, the user is required to pick up and manipulate the box to perform the cutting operation. Because the sharp teeth are most often obscured from view by the overlying sheet it is not uncommon for the user to inadvertently cut themselves; sometimes very seriously. This inherent danger of conventional dispensing cartons is well known to their producers, but unfortunately not always to the end user.

Heretofore, a variety of alternatives to serrated cutting members have been devised to obviate the risks attendant therewith. One prior art approach to cutting flexible sheet materials is to adapt the dispenser with a track assembly having a slidable cutting tool mounted thereon. The sheet is pulled from the dispenser across the tracks and the cutting tool drawn across the sheet to perform the severing operation.

For example, Publication No. 2005/0005755 of Turvey et al. teaches a dispenser for sheet material which includes a box and a cutting apparatus attached to the box, wherein the cutting apparatus includes a track assembly and a slider assembly disposed on the track assembly for movement therealong.

U.S. Pat. No. 4,787,284 issued to Chen discloses a cutting apparatus for wrap film. The apparatus includes a sliding saddle mounted in a sliding manner in a guiding track slot of a cardboard dispenser box. The sliding saddle includes a T-shaped upper half portion and an I-shaped lower half portion connected by a mid-prop. The I-shaped lower half portion is mounted on the guiding track slot such that the mid-prop and T-shaped upper half portion extend above the slot. The mid-prop includes a razor on a front portion thereof for cutting wrap film. The Chen device shrouds the cutting blade to avoid accidental contact therewith. Still other variations of this basic slidable cutting arrangement may be seen in U.S. Pat. No. 5,440,961 issued to Lucas, Jr. et al., U.S. Pat. Nos. 4,210,043 and 4,245,536 issued to Urion, U.S. Publication No. 2004/0007606 of Baker et al. and U.S. Pat. No. 6,223,639 issued to Chen. Note that in all of these references the sheet to be cut is placed on top of the rails and therefore is capable of movement during the cutting process resulting in uneven cuts and bunching of the sheet material in front of the traveling blade. To overcome this problem, some of the above apparatus provide cutting assemblies adapted to temporarily immobilize the sheet local to the blade, but do not secure the entire width of the sheet during the entire cutting operation.

A different type of cutting apparatus involves trapping the sheet material under a moveable track assembly before the cutting operation is performed. By immobilizing the entire width of the sheet it is possible to achieve a straighter cut and avoid tearing and bunching. An example of such an apparatus is described in U.S. Pat. No. 3,142,217 issued to Busse and is comprised of a container having a hinged cover that extends beyond the front face of the container in cantilevered fashion, the cover being adapted with a slidable cutting assembly, and a cantilevered shelf extending perpendicular to the front face and under the cutting assembly. In operation, the cover is lifted up, a sheet drawn out to the desired length, the cover lowered to its closed position such that the sheet is trapped between the shelf and the cutting assembly, and the cutter drawn across the sheet in conventional fashion. A significant shortcoming of this arrangement of components is that it results in an oddly shaped container that is ill-suited for bulk packaging and storage on grocery store shelves. The Busse apparatus would also take up an unnecessary amount of valuable kitchen drawer space. Moreover, the invention of Busse is not adaptable to containers designed to dispense the sheet goods through a slot or other type opening located in its front face.

In view of the shortcomings and limitations of the above described prior art, it is clear that a need still exists for a simple and reliable cutting apparatus that may be used in conjunction with both front and top dispensing storage boxes for rolled sheet goods and that is detachable for reuse on multiple containers.

### SUMMARY OF THE INVENTION

The subject invention more specifically relates to a cutting apparatus for top and front dispensing containers for rolled sheet goods and is comprised generally of: 1) a pivotable track assembly capable of engaging and immobilizing a sheet for cutting as more fully described herein, 2) a pair of opposing hinge arms each fixedly attached at their distal end to the opposing ends of the track assembly, 3) mounting means attached to the proximal ends of the hinge arms for mounting of the track assembly to opposing side walls of the container in pivotable fashion, and 4) a cutting assembly slidably disposed on the track assembly. When mounted to the container, the track and cutting assemblies may be rotated from an open sheet loading position to a closed sheet trapping and cutting position against either the top or front panel of the container, depending on the point of attachment of the apparatus to the container. More specifically, the apparatus may be mounted to the upper rear corners of the side walls of the container such that the track assembly comes into abutting engagement with the top panel of the container when the track assembly is in its closed position. This mounting location would be desirable for containers that are designed for dispensing the sheet material through the top panel. Alternatively, the apparatus may be mounted to the upper front corners of the side walls of the container such that the track assembly comes into abutting engagement with the front panel of the container when the track assembly is in its closed position. This mounting location would be desirable for containers that are designed for dispensing the sheet material through the front panel.

The subject apparatus may be employed as a sheet cut without lifting the container off of its resting surface. In operation, the track assembly is first pivoted to its open position; the sheet material is threaded through the opening of the container and drawn across the cutting surface thereof (either the top or front panel of the container, or a backing strip mounted to these surfaces) until the desired sheet length is achieved; the track assembly rotated to its closed position trapping the sheet between the track assembly and the cutting surface while simultaneously causing the cutting blade to come into perforating engagement with the sheet; and then moving the cutting assembly back and forth across the track assembly to achieve complete severance of the work piece from the parent body.

There has thus been outlined, rather broadly, the more important components and features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is, therefore, a primary object of the subject invention to provide an improved cutting apparatus for rolled sheet goods, the apparatus being readily mountable to a variety of conventional dispensers of such goods including those adapted for dispensing of the sheet material through either the top or front panels.

It is another primary object of the subject invention to provide a cutting apparatus for rolled sheet goods including means for immobilizing the work sheet prior to the cutting operation, said means comprising a pivoting track assembly which may be rotated to trap the sheet against a cutting surface on both sides of the cut.

Yet another primary object of the subject invention is to provide a cutting apparatus for rolled sheet goods including means for not only immobilizing the work sheet prior to cutting, but also means for tensioning the sheet material to facilitate cutting without bunching.

It is also an object of the subject invention to provide a sheet cutting apparatus that is comprised of relatively few components to facilitate easy assembly and use as well as reduce the chances of mechanical failure.

Another object of the subject invention is to provide a sheet cutting apparatus which is relatively simple in design and therefore capable of rapid construction at relatively low costs.

Still another object of the subject invention is to provide a sheet cutting apparatus which is safe to operate and serves as an alternative to conventional serrated cutting strips.

And still another object of the subject invention is to provide a sheet cutting apparatus which is inexpensive enough to be disposable, but capable of reuse on multiple containers if desired.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the subject cutting apparatus for rolled sheet goods;

FIG. 2 is a perspective view of the invention of FIG. 1 shown mounted to a dispensing container for sheet material such that the track assembly when in its closed position is situate in abutting relation to the top panel of the container;

FIG. 3 is a perspective view of the invention of FIG. 1 shown in an alternate mounting arrangement wherein the track assembly when in its closed position is situate in abutting relation to the front panel of the container;

FIG. 4 is a front view of the subject invention shown mounted to a dispensing container for sheet material;

FIG. 5 is a sectional view taken along lines 5-5 of FIG. 4;

FIG. 6 is a side view of a hinge arm of the subject invention and illustrating in particular the relationship between the axis of rotation of the hinge arm and the points of attachment of the rail components of the track assembly;

FIG. 7 is a side view of an alternate embodiment of a hinge arm of the subject invention;

FIG. 8 is a second embodiment of the mounting means of the subject invention shown piercing a side wall of a dispensing container for rolled sheet goods;

FIG. 9 is an enlarged side view of sheet material trapped between rails and backing strip components of the subject invention; and

FIG. 10 is an enlarged side view of an alternate mating relationship between rails and backing strip components of the subject invention

### DETAILED DESCRIPTION OF THE PREFERRED EMBODIMENT

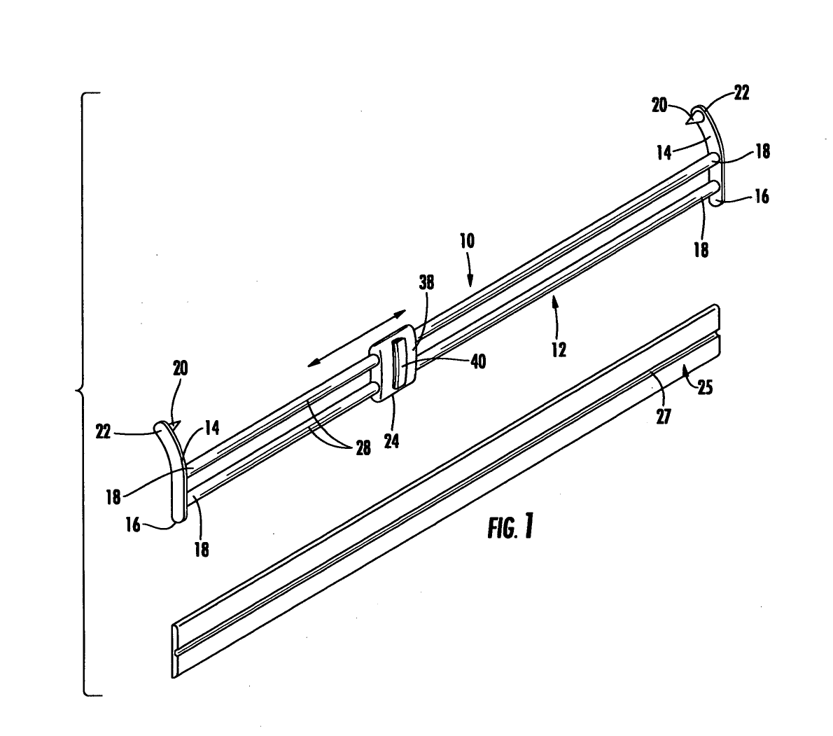

Reference is first made to FIG. 1 in which there is illustrated a perspective view of the subject cutting apparatus for rolled sheet goods designated generally by reference numeral 10. In its broadest sense, the subject invention is a slidable cutting apparatus capable of operable attachment to a variety of commercially available dispensing containers for rolled sheet goods such as metal foils, plastic wraps and wax paper, and is comprised of four primary components, namely: 1) a pivotable track assembly 12 capable of engaging, immobilizing and in one embodiment tensioning a work object (sheet material) 200 for cutting as more fully described herein, 2) a pair of opposing hinge arms 14 each fixedly attached at their distal end 16 to opposite ends 18 of track assembly 12, 3) mounting means attached to the proximal ends 22 of hinge arms 14 for mounting of the track assembly to opposing side walls of the container in pivotable fashion, and 4) a cutting assembly 24 slidably disposed on track assembly 12. In alternate embodiments, a backing strip 25 with blade receiving channel 27 is provided in mating engagement with track assembly 12 in the manner and for the purposes described herein.

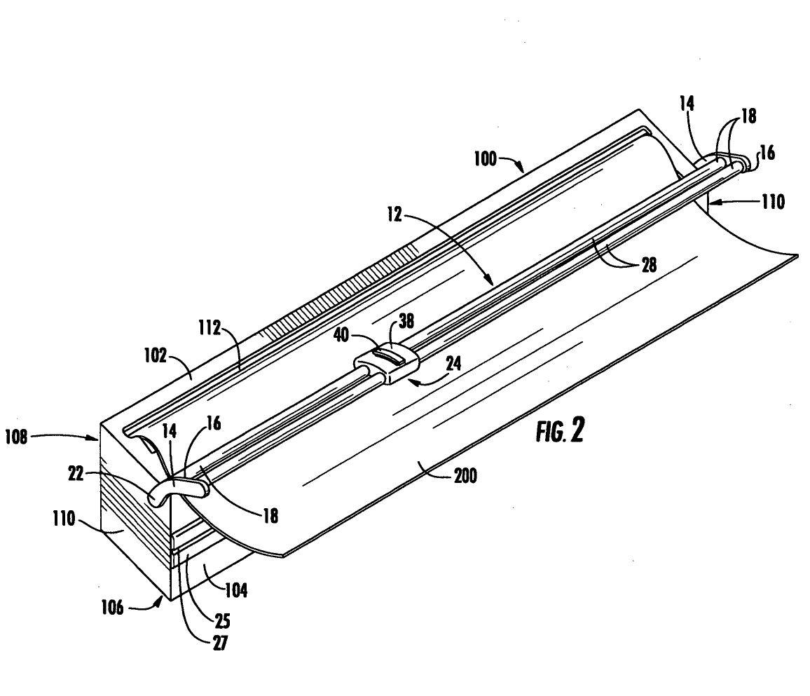

Before elaborating on the construction and arrangement of the above components, it is necessary to understand the construction of the article to which the subject apparatus may be mounted. Several apparatus for both retaining and dispensing rolled sheet goods are commercially available. Referring to FIGS. 2 and 3, for instance, a conventional storage apparatus 100 for rolled sheet goods is comprised of top panel 102, front panel 104, bottom panel 106 and rear panel 108 each disposed between two side walls 110 to form an elongated container as illustrated which is usually constructed of cardboard. Each such storage apparatus will have an opening 112 through which the sheet material is dispensed. In some instances, such as illustrated in FIG. 2, the opening will be located in the top panel 102 of the container; in others it will be located in the front panel 104 (FIG. 3). The subject apparatus is designed to be detachably mounted to containers of either configuration.

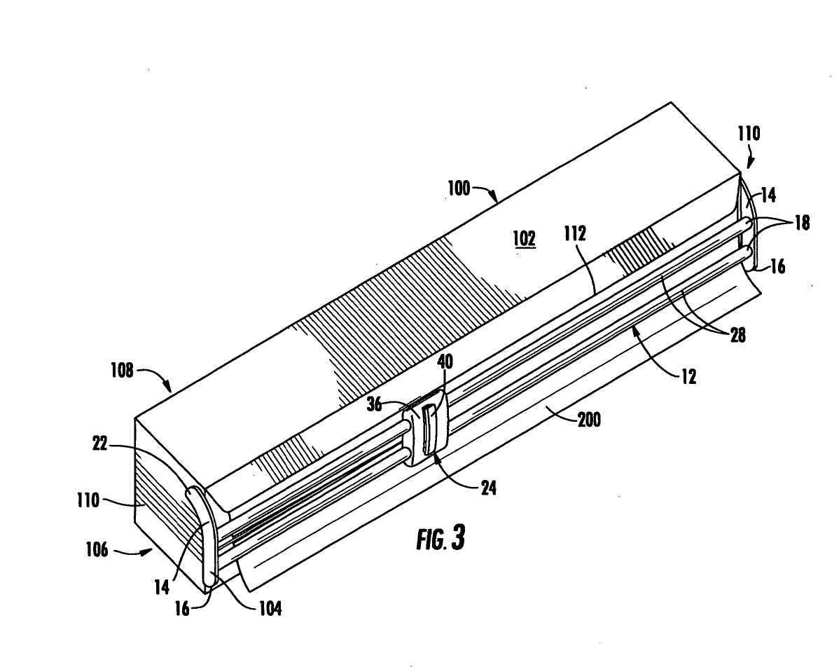

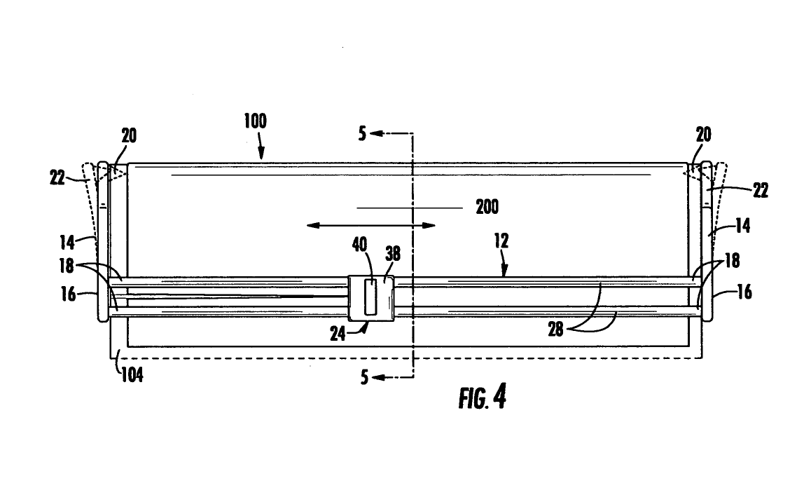

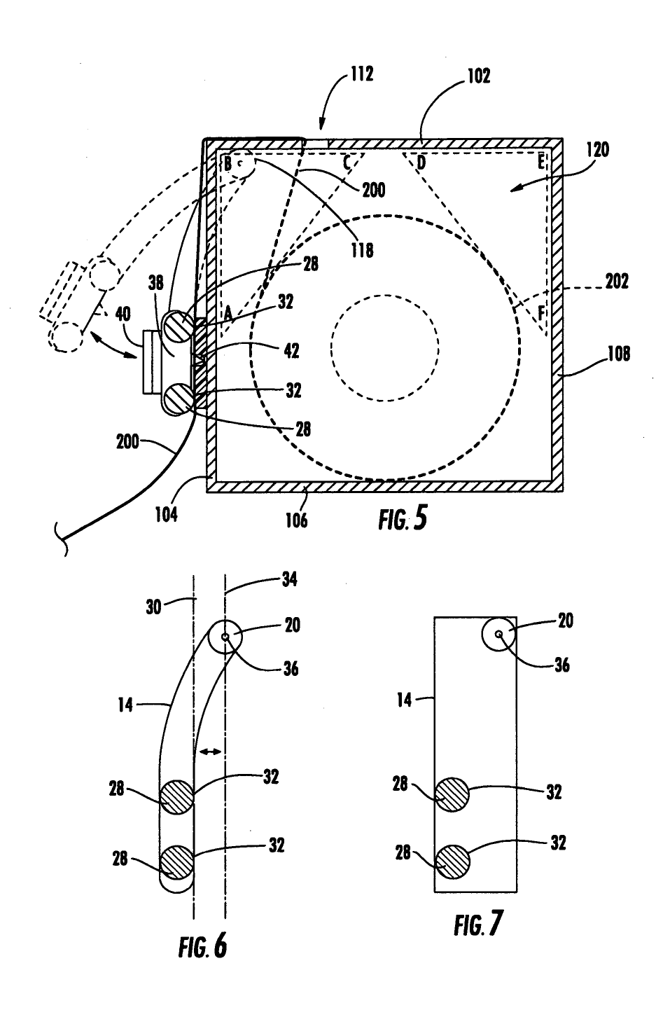

Reference now being made to FIG. 4, a front elevation view of the subject cutting apparatus 10 is illustrated mounted to a dispensing container 100. Track assembly 12 is comprised of a pair of parallel rails 28 which are preferably but not essentially circular in cross section (see FIG. 5, for instance) and which are substantially similar in length as container 100 to which they are mounted. Rails 28 are spaced apart from one another forming slot 30 and are maintained in this position via the fixed attachment of their opposing ends 18 to the distal ends 16 of each hinge arm 14 in perpendicular fashion. Thusly connected, hinge arms 14 also serve as slide stops which limit the degree of travel of cutting assembly 24 over rails 28 and prevent inadvertent axial dislodgement of the former from the latter.

As alluded to above, each hinge arm 14 terminates in proximal end 22 which, in turn, is attached to mounting means which in a preferred embodiment is comprised of a pair of conically shaped spikes 20 each having a pointed tip for piercing the cardboard side wall 110 on opposing sides of container 100. In order to accomplish this action, hinge arms 14 are made of a semi-rigid plastic material such that they may be manually flexed along their longitudinal axis as shown in FIG. 4 until the distance between the tips of the opposing spikes is greater than the width of container 100. Spikes 20 are then guided over the desired mounting areas of side panels 110 and the proximal ends 22 of hinge arms 14 released allowing the tips of spikes 20 to spring back until their tips come into piercing engagement with the cardboard sidewalls. Additional force may be applied to the proximal ends of each hinge arm 14, such as using thumb pressure for instance, until each hinge arm is returned to its original non-flexed configuration with spikes 20 inserted into each side wall 110. Because of the smooth conical shape of each spike they are capable of rotation within the aperture which they have created. Accordingly, depending track assembly 12 is capable of rotation about the central axis of rotation of each spike 20. In an alternate embodiment (FIG. 8), a shaft 21 is disposed between each spike 20 and hinge arm 14. Shaft 21 has a diameter less than that of spike 20 and a length greater than the thickness of a side wall 110 of container 100. When spike 20 passes through side wall 110 shaft 21 comes to rest on the side wall as shown thereby trapping spike 20 inside container 100 to prevent it from becoming dislodged.

Referring now to FIG. 5, a cross sectional view of the storage container 100 of FIG. 4 is illustrated having the subject apparatus mounted thereon. An important feature of the subject cutting apparatus 10 is that it may be selectively mounted to container 100 such that track assembly 12 comes into abutting engagement with either top panel 102 (FIG. 2) or front panel 104 (FIG. 3) depending upon which location is more conducive to the cutting process. In a most basic embodiment of the subject apparatus, a portion of the top or front panel will serve as the cutting surface upon which sheet 200 will be disposed (namely that portion directly under track assembly 12). However, in preferred embodiments, an elongated backing strip 25 is applied across the top or front panel of the container, directly under and in longitudinal alignment with rails 28 of track assembly 12. Backing strip 25 includes a channel 27 disposed longitudinally there through for receiving the cutting member of the subject apparatus as shown and as more fully described below. Backing strip 25 is substantially equal in length to rails 28 and may include mounting means preferably but not essentially in the form of a peel-and-stick adhesive to mount the strip to container 100.

In most instances, where opening 112 through which the sheet material 200 is dispensed is located in the front panel 104, a “top panel mounting” will be preferred (FIG. 2). In those instances where opening 112 is located in the top panel 104, a “front panel mounting” will be preferred (FIG. 3). In either instance, one of two regions of each sidewall 110 will be utilized for mounting of mounting means 20 as described below.

Because of the circular cross section of the roll of sheet material 200, and the square cross section of container 100, there exist areas of free space between the exterior surface 202 of the roll of sheet material 200 and the interior corners 116 of container 100. Since empty space exists behind sidewalls 110 in these areas they make ideal locations for the penetration of mounting means 20. A first mounting region 118 is defined by triangle ABC of FIG. 5. A second mounting region 120 is defined by triangle DEF.

With reference now being made to FIG. 6, note that in order for rails 28 to both lie flush against the surface of either container 100 or backing strip 25 it is necessary for mounting means 20 to be offset from the axis 30 defined by sheet engaging surfaces 32 of rails 28. A distance of approximately 5-10 mm between sheet engaging surfaces 32 and a parallel axis 34 occupied by axis of rotation 36 is typically ideal for this purpose. To accomplish this set off, hinge arms 14 may be curved or angled to minimize the amount of material needed for construction of this component. In other embodiments such as the one illustrated in FIG. 7, hinge arm 14 may be rectangular in shape or otherwise, so long as mounting means 20 and rails 28 occupy separate but parallel axes properly spaced from one another.

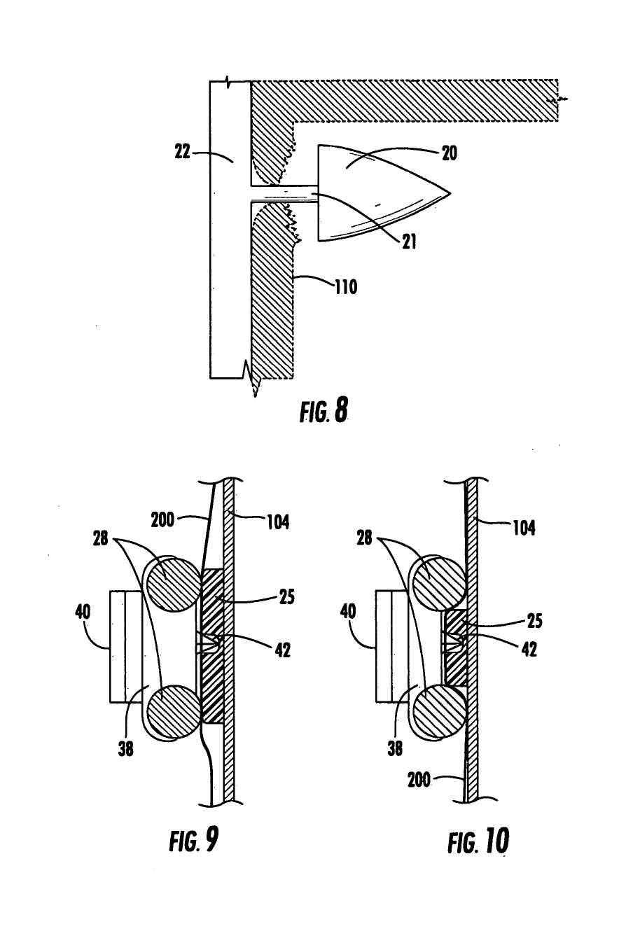

When properly mounted, rails 28 of track assembly 12 are capable of pivotal entrapment of sheet 200 against a cutting surface which may be either top or front panel 102 and 104, respectfully, or a backing strip 25 mounted to the same. Light hand pressure may be added to track assembly 12 during the cutting operation to further restrain sheet 200 from movement. Alternatively, track assembly 12 or cutting assembly 24 may be weighted to achieve the same result, particularly when track assembly 12 is mounted over top panel 102. In yet another embodiment, rails 28 and backing strip 25 may be adapted with or entirely comprised of magnets such that the pivotable rails 28 are attracted to the stationary backing strip 25 causing sheet 200 to be trapped in between (FIG. 9). In this embodiment, no hand pressure is required to restrain sheet 200 from movement.

The final primary component of the subject cutting apparatus 10 is cutting assembly 24 which is slidably disposed on track assembly 12. Track assembly 12 is comprised of carriage 38 in sliding communication with rails 28, push tab 40 attached perpendicularly to carriage 38 and against which force is applied to cause movement of carriage 38 across rails 28, and cutting member 42 fixedly mounted to carriage 38 so as to project perpendicularly from the bottom surface thereof between rails 28. In the embodiment of the invention shown in FIGS. 5 and 9 it is important that the cutting edges of cutting member 42 extend beyond the sheet engaging surface 32 of each rail 28, but not so far as to come into contact with the bottom of channel 27 of backing strip 27. Thusly situated, cutting member 42 may come into severing engagement with sheet 200, but will not be dulled through contact with the backing strip. Note that in this embodiment, backing strip 25 has a width great enough to permit both rails 28 to come into contact with its planar surface. Cutting member 42 may be constructed of a variety of materials including metals and plastics and shaped in a variety of ways which are well known to those skilled in the art.

In practice, the subject cutting apparatus 10 is first mounted such that its track assembly 12 is situate over either top panel 102 or front panel 104 as described above. Backing strip 25 may then be optionally mounted onto either top panel 102 or front panel 104 directly underneath track assembly 12 such that rails 28 engage the surface of the backing strip; one rail 28 above channel 27 and one rail below. As best observed upon reference to FIG. 5, once the apparatus is properly mounted, track assembly 12 is first pivoted to its open position and sheet material 200 is drawn there under from opening 112 of container 100 and drawn across backing strip 25 (or across the cutting surface of either top panel 102 or front panel 104 when no backing strip is used) until the desired sheet length is achieved. Track assembly 12 is then pivoted to its closed position trapping sheet 200 between sheet engaging surfaces 32 of rails 18 and the underlying backing strip 25 (top panel 102 or front panel 104 of dispensing container 100 when no backing strip is used). This action simultaneously causes cutting member 42 to come into perforating engagement with sheet 200. Manual force is then applied to push tab 40 to move carriage 38 laterally across rails 18 in a back and forth motion causing cutting member 42 to sever the underlying work object (sheet 200) from its parent body.

Referring to FIG. 10, an alternate embodiment of the subject cutting apparatus is shown wherein cutting member 42 is recessed between rails 28 such that its tip does not extend beyond the plane of sheet engaging surfaces 32. This is the safest embodiment of the subject invention since cutting member 42 is shrouded to prevent incidental contact with the user's hands or fingers. To accomplish this arrangement of components, the bottom of carriage 38 from which cutting member 42 depends is also recessed between rails 38 preferably but not essentially to a depth equal to the radius of each rail 28. In this embodiment, backing strip 25 has a width substantially equal to the distance between rails 28 and a thickness less than the radius of each rail 28. Accordingly, as rails 28 are pivoted to their closed position against container 100 both above and below backing strip 25 which now lay between each rail, and more particularly as sheet engaging surfaces 32 trap sheet 200 against the surface of container 100, sheet 200 is caused to be pulled taught across the surface of backing strip 25. Not only is sheet 200 immobilized between rails 28 and container 100, but the action of “stretching” sheet 200 across the elevated backing strip 25 causes tensioning of the sheet which facilitates its cutting.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto.

What is claimed as being new, useful and desired to be protected by Letters Patent of the United States is as follows:

1. A cutting apparatus for rolled sheet goods stored within a dispensing box having top, bottom, front and back panels disposed between opposing side walls, the cutting apparatus comprising:
a) a first hinge arm having a distal end and a proximal end;
b) a second hinge arm having a distal end and a proximal end;
c) a pair of rails disposed between said distal ends of said first and said second hinge arms in parallel fashion;
d) mounting means attached to said proximal ends of said first hinge arm and said second hinge arm for mounting of the cutting apparatus to the opposing side walls of the container in pivotable fashion; and
e) a cutting assembly slidably disposed on said track assembly.

2. The cutting apparatus of claim 1 wherein said mounting means is comprised of a first spike attached to said proximal end of said first hinge arm, and a second spike attached to said proximal end of said second hinge arm, said first spike and said second spike being capable of piercing and rotational engagement with the opposing side walls of the dispensing box.

3. The cutting apparatus of claim 2 further including a first shaft axially disposed between said first spike and said proximal end of said first hinge arm, and a second shaft axially disposed between said second spike and said proximal end of said second hinge arm.

4. The cutting apparatus of claim 1 wherein said first hinge arm and said second hinge arm are flexible.
